(19) United States
(12) Patent Application Publication
(10) Pub. No.: US 2023/0063523 A1
(43) Pub. Date: Mar. 2, 2023

(54) ROTOR, MOTOR, BLOWER, AIR CONDITIONER, AND MANUFACTURING METHOD OF ROTOR

(71) Applicant: Mitsubishi Electric Corporation, Tokyo (JP)

(72) Inventors: Hiroki ASO, Tokyo (JP); Takanori WATANABE, Tokyo (JP); Kazuchika TSUCHIDA, Tokyo (JP); Takaya SHIMOKAWA, Tokyo (JP); Ryogo TAKAHASHI, Tokyo (JP)

(21) Appl. No.: 17/790,037

(22) PCT Filed: Feb. 26, 2020
(86) PCT No.: PCT/JP2020/007749

§ 371 Date: Jun. 29, 2022

(51) Int. Cl. H02K 1/2746; H02K 1/276

(52) U.S. Cl. CPC H02K 1/2746; H02K 1/2766

(57) ABSTRACT

A rotor includes a rotary shaft, a rotor core including a first core part and a second core part arranged to adjoin each other in a circumferential direction, and a permanent magnet provided in the first core part. A virtual magnetic pole is formed in the second core part. The first core part includes a cavity portion formed on an inner side in a radial direction of the rotor core relative to the permanent magnet. The cavity portion includes a first portion whose width in the circumferential direction increases toward the rotary shaft. A surface defining the cavity portion, being located on an innermost side of the cavity portion in the radial direction and facing outward in the radial direction is located on the inner side in the radial direction relative to an innermost portion of the second core part in the radial direction.

### CROSS-REFERENCE TO RELATED APPLICATION

This application is a U.S. National Stage Application of International Application No. PCT/JP2020/007749 filed on Feb. 26, 2020 the contents of which are incorporated herein by reference.

### TECHNICAL FIELD

The present disclosure relates to a rotor, a motor, a blower, an air conditioner, and a manufacturing method of the rotor.

### BACKGROUND

As a rotor of a motor, there has been proposed a rotor of a consequent-pole type in which a part of a rotor core functions as a virtual magnetic pole. See Patent Reference 1, for example.

In the Patent Reference 1, a salient pole formed on the rotor core functions as a virtual magnetic pole. Further, in the Patent Reference 1, the rotor includes a slit that causes magnetic flux emitted from a permanent magnet to flow into the salient pole.

### Patent Reference

Patent Reference 1: Japanese Patent Application Publication No. 2011-103759

However, the width in the circumferential direction of the slit described in the Patent Reference 1 is constant irrespective of the position in a radial direction. Thus, there is a problem in that the amount of magnetic flux emitted from a permanent magnet and flowing into the salient pole through a part of the rotor core located on an inner side in the radial direction relative to the permanent magnet is small. Further, the rotor core in the Patent Reference 1 engages with a rotary shaft at their cylindrical surfaces, and thus there is also a problem in that the transmissibility of torque from the rotor core to the rotary shaft may be insufficient.

### SUMMARY

An object of the present disclosure is to increase the amount of the magnetic flux emitted from the permanent magnet and flowing into the virtual magnetic pole and to improve the transmissibility of torque to the rotary shaft.

A rotor according to an aspect of the present disclosure includes a rotary shaft, a rotor core supported by the rotary shaft and including a first core part and a second core part arranged to adjoin each other in a circumferential direction, and a permanent magnet provided in the first core part. A virtual magnetic pole is formed in the second core part. The first core part includes a cavity portion formed on an inner side in a radial direction of the rotor core relative to the permanent magnet. The cavity portion includes a first portion whose width in the circumferential direction increases toward the rotary shaft. A surface defining the cavity portion, being located on an innermost side of the cavity portion in the radial direction and facing outward in the radial direction is located on the inner side in the radial direction relative to an innermost portion of the second core part in the radial direction.

According to the present disclosure, the amount of the magnetic flux emitted from the permanent magnet and flowing into the virtual magnetic pole can be increased, and the transmissibility of torque to the rotary shaft can be improved.

### BRIEF DESCRIPTION OF THE DRAWINGS

FIG. 1 is a configuration diagram showing a partial cross section of a motor according to a first embodiment.

FIG. 2 is a sectional view of a rotor and a mold stator shown in FIG. 1 taken along the line A2-A2.

FIG. 3 is a side view showing a part of the rotor according to the first embodiment.

FIG. 4 is a sectional view of the rotor shown in FIG. 3 taken along the line A4-A4.

FIG. 5 is a plan view showing a rotor core and permanent magnets of the rotor according to the first embodiment.

FIG. 6 is a schematic diagram showing the flow of magnetic flux in a rotor according to a first comparative example.

FIG. 7 is a schematic diagram showing the flow of magnetic flux in the rotor according to the first embodiment.

FIG. 8 is a graph showing a relationship between a noise level of the motor and a ratio (t₁/t₀) of a thickness of a part between a magnet insertion hole and a cavity portion to a sheet thickness of an electromagnetic steel sheet of the rotor according to the first embodiment.

FIG. 9 is a schematic diagram showing the flow of magnetic flux in a second core part of a rotor according to a second comparative example.

FIG. 10 is a sectional view showing the configuration of the rotor according to the first embodiment.

FIG. 11 is a diagram of the rotor shown in FIG. 10 as viewed from a +z-axis side.

FIG. 12 is a diagram of the rotor shown in FIG. 10 as viewed from a −z-axis side.

FIG. 13 is a diagram showing the flow of shaft current in a motor according to a third comparative example with bidirectional arrows.

FIG. 14 is a flowchart showing a manufacturing process of the rotor according to the first embodiment.

FIG. 15 is a sectional view showing the configuration of a mold used in the manufacturing process of the rotor according to the first embodiment.

FIG. 16 is a plan view showing a rotor according to a second embodiment.

FIG. 17 is a plan view showing a rotor according to a third embodiment.

FIG. 18 is a plan view showing a rotor according to a fourth embodiment.

FIG. 19 is a diagram showing the configuration of an air conditioner employing the motor including the rotor in any one of the first to fourth embodiments.

FIG. 20 is a sectional view showing the configuration of an outdoor unit shown in FIG. 19.

### DETAILED DESCRIPTION

A rotor, a motor, a blower, an air conditioner, and a manufacturing method of a rotor according to each embodiment of the present disclosure will be described below with reference to the drawings. The following embodiments are just examples and it is possible to appropriately combine embodiments and appropriately modify each embodiment.

An xyz orthogonal coordinate system is shown in the drawings to facilitate the understanding of the description. A z-axis is a coordinate axis parallel to an axis of a rotor. An x-axis is a coordinate axis orthogonal to the z-axis. A y-axis is a coordinate axis orthogonal to both the x-axis and the z-axis.

### First Embodiment

### (Motor)

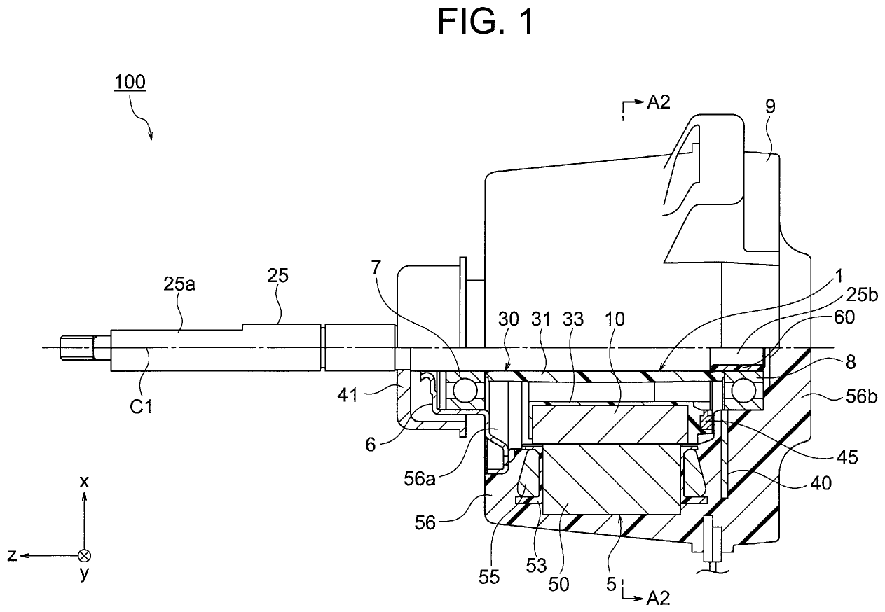

FIG. 1 is a configuration diagram showing a partial cross section of a motor 100 according to a first embodiment. The motor 100 includes a rotor 1 and a mold stator 9 that surrounds the rotor 1. The mold stator 9 includes a stator 5 and a mold resin portion 56 that covers the stator 5. The rotor 1 is arranged inside the stator 5. Namely, the motor 100 is a motor of the inner rotor type.

The rotor 1 includes a rotor core 10, a shaft 25 as a rotary shaft, and a first bearing 7 and a second bearing 8 that rotatably support the shaft 25. The rotor 1 is rotatable about an axis Cl of the shaft 25. The shaft 25 projects from the mold stator 9 toward the +z-axis side. To a tip end portion 25a of the shaft 25, a fan of a blower (i.e., an impeller 504 of an outdoor blower 150 which will be described later) is attached, for example.

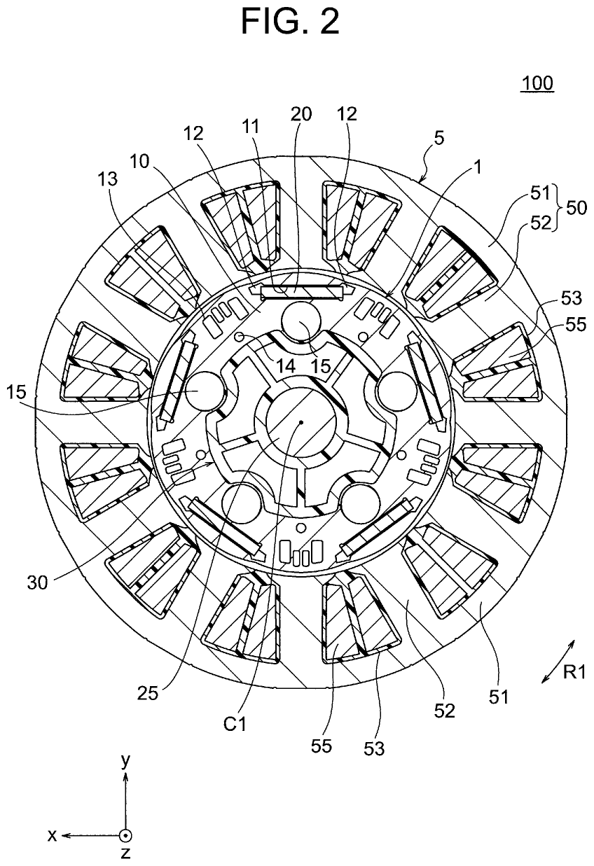

In the following description, the z-axis direction is referred to as an “axial direction”, a direction orthogonal to the axial direction is referred to as a “radial direction”, and a direction along a circumference of a circle centering at the axis Cl of the shaft 25 is referred to as a “circumferential direction” (for example, the arrow R1 shown in FIG. 2). Further, the projecting side (i.e., the +z-axis side) of the shaft 25 is referred to also as a “load side”, and a side of the shaft 25 opposite to the projecting side is referred to also as a “counter-load side”.

The first bearing 7 and the second bearing 8 are rolling bearings, such as ball bearings, for example. The first bearing 7 is a bearing on the load side. The first bearing 7 rotatably supports a part of the shaft 25 projecting from the mold stator 9. The second bearing 8 is a bearing on the counter-load side. The second bearing 8 rotatably supports an end portion 25b of the shaft 25 on the −z-axis side via an insulation sleeve 60 which will be described later.

The rotor 1 may further include a sensor magnet 45 as a magnet for position detection. For example, the sensor magnet 45 is attached to a part on the −z-axis side relative to the rotor core 10 and faces a circuit board 40. A magnetic field of the sensor magnet 45 is detected by a magnetic sensor (not shown) provided on the circuit board 40, by which the position of the rotor 1 in the circumferential direction R1 is detected.

FIG. 2 is a sectional view of the rotor 1 and the mold stator 9 shown in FIG. 1 taken along the line A2-A2. Incidentally, illustration of the mold resin portion 56 of the mold stator 9 is omitted in FIG. 2. As shown in FIGS. 1 and 2, the stator 5 includes a stator core 50 and a coil 55 wound on the stator core 50.

The stator core 50 includes a yoke 51 in an annular shape about the axis Cl and a plurality of teeth 52 extending inward in the radial direction from the yoke 51. A tip end portion of each tooth 52 faces the rotor 1 in the radial direction via an air gap. The plurality of teeth 52 are arranged at equal intervals in the circumferential direction R1. In the first embodiment, the number of teeth 52 is 12, for example. Incidentally, the number of teeth 52 is not limited to 12. It is sufficient that the number of teeth 52 is 2 or more. The coil 55 is wound on the stator core 50 via an insulator 53. The insulator 53 is formed of a resin material such as PBT (PolyButylene Terephthalate), for example.

As shown in FIG. 1, the mold resin portion 56 includes an opening portion 56a and a bearing holding portion 56b. The opening portion 56a is formed on the +z-axis side of the mold resin portion 56. A bracket 6 holding the first bearing 7 is attached to the opening portion 56a. The bracket 6 is a member made of metal, for example. The bearing holding portion 56b is formed on the −z-axis side of the mold resin portion 56. The second bearing 8 is held by the bearing holding portion 56b. The mold resin portion 56 is formed of a thermosetting resin such as BMC (Bulk Molding Compound) resin, for example.

The circuit board 40 is embedded in the mold resin portion 56. In FIG. 1, the circuit board 40 is arranged on the −z-axis side relative to the rotor 1 in the mold resin portion 56. Wires such as power supply lead wires for supplying electric power to the coil 55 are wired on the circuit board 40.

The motor 100 may further include a cap 41. The cap 41 is fixed to the shaft 25 so as to cover a part of the bracket 6. The cap 41 is a member that prevents entry of foreign matter (for example, water or the like) into the inside of the motor 100.

### (Rotor)

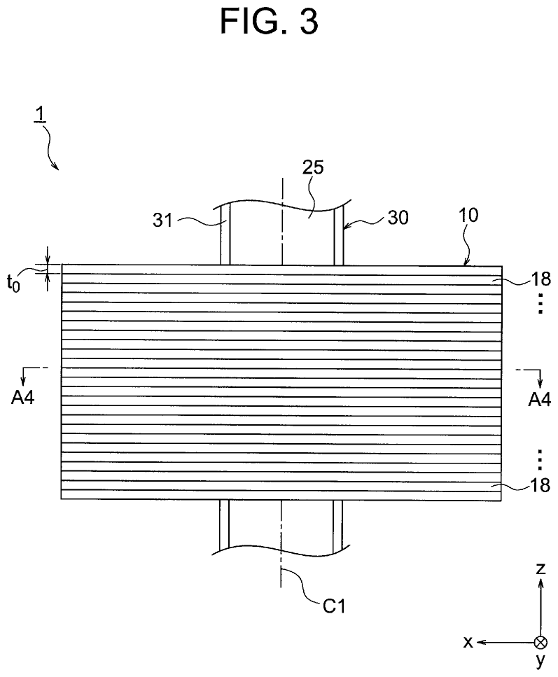

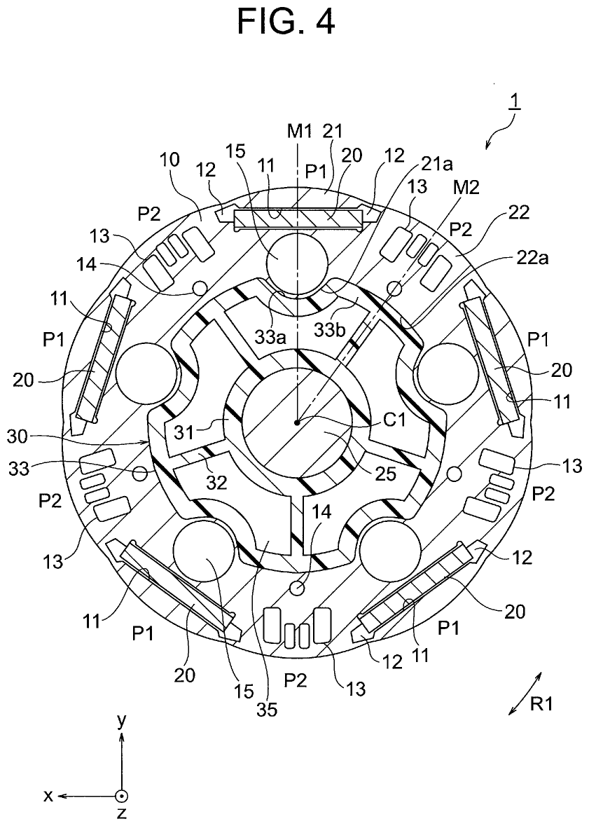

Next, a detailed configuration of the rotor 1 will be described below by using FIGS. 2 to 4. FIG. 3 is a side view showing a part of the rotor 1. FIG. 4 is a sectional view of the rotor 1 shown in FIG. 3 taken along the line A4-A4. As shown in FIGS. 2 to 4, the rotor core 10 of the rotor 1 is a member in an annular shape about at the axis Cl. A hollow portion 10c of the rotor core 10 is an insertion hole in which the shaft 25 is inserted. Namely, the hollow portion 10c surrounds the periphery of the shaft 25.

The rotor core 10 includes a plurality of electromagnetic steel sheets 18 stacked in the axial direction. A sheet thickness t₀ (see FIG. 3) of one electromagnetic steel sheet 18 in the plurality of electromagnetic steel sheets 18 is 0.1 mm to 0.5 mm, for example. Each of the plurality of electromagnetic steel sheets 18 is processed into a predetermined shape by stamping processing using a pressing die. The plurality of electromagnetic steel sheets 18 are fixed together by means of welding, crimping, adhesion or the like. In the first embodiment, the plurality of electromagnetic steel sheets 18 are fixed together by means of crimping.

The rotor core 10 is provided with permanent magnets 20. In the first embodiment, the permanent magnets 20 are embedded in the rotor core 10. Namely, the rotor 1 has the IPM (Interior Permanent Magnet) structure. Incidentally, the rotor 1 may also have the SPM (Surface Permanent Magnet) structure in which the permanent magnets 20 are attached to the outer periphery of the rotor core 10.

The rotor 1 may further include a connection portion 30 that connects the rotor core 10 and the shaft 25 to each other. Namely, in the first embodiment, the rotor core 10 is supported by the shaft 25 via the connection portion 30. The connection portion 30 is formed of a resin material having an electrical insulation property. The connection portion 30 is formed of a thermoplastic resin such as PBT, for example. The rotor core 10, the shaft 25 and the insulation sleeve 60 which will be described later are integrated together via the connection portion 30 made of the resin. Incidentally, in the following description, integrating the rotor core 10 to which the permanent magnets 20 are attached, the shaft 25, and the insulation sleeve 60 together by using a resin is referred to as “integral molding”.

As shown in FIG. 4, the connection portion 30 includes an inner cylinder portion 31, a plurality of ribs 32, and an outer cylinder portion 33. The inner cylinder portion 31 is in an annular shape and is in contact with an outer peripheral surface of the shaft 25. The outer cylinder portion 33 is in contact with an inner peripheral surface of the rotor core 10. The plurality of ribs 32 connect the inner cylinder portion 31 and the outer cylinder portion 33 to each other. The plurality of ribs 32 radially extend outward in the radial direction from the inner cylinder portion 31. The plurality of ribs 32 are arranged at equal intervals in the circumferential direction R1 about the axis Cl. Between the ribs 32 adjoining each other in the circumferential direction R1, a hollow portion 35 extending in the axial direction through the connection portion 30 is formed.

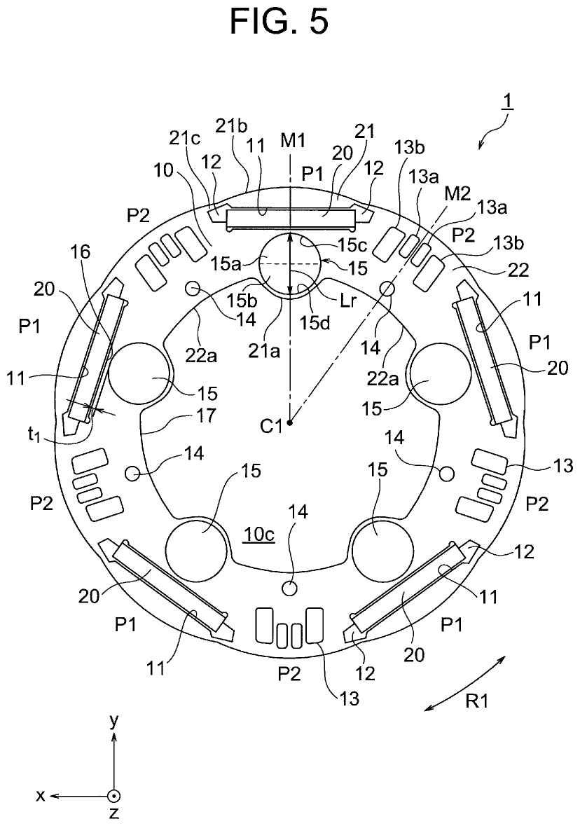

FIG. 5 is a plan view showing the rotor core 10 and the permanent magnets 20 of the rotor 1. As shown in FIG. 5, the rotor core 10 includes first core parts 21 to which permanent magnets 20 are attached and second core parts 22 to which no permanent magnets 20 are attached. In the first embodiment, the rotor core 10 includes a plurality of (for example, five) first core parts 21 and a plurality of (for example, five) second core parts 22. The plurality of first core parts 21 and the plurality of second core parts 22 are arranged alternately in the circumferential direction R1. Namely, the first core parts 21 and the second core parts 22 are arranged to adjoin each other in the circumferential direction R1.

The first core part 21 includes a magnet insertion hole 11 as a magnet insertion portion. The magnet insertion hole 11 is formed on an inner side in the radial direction relative to an outer periphery 21b of the first core part 21. The shape of the magnet insertion hole 11 is a linear shape in a plan view, for example. In the first embodiment, one permanent magnet 20 is inserted in each magnet insertion hole 11. A resin material (for example, PBT) which is not illustrated is filled between the magnet insertion hole 11 and the permanent magnet 20. Incidentally, the shape of the magnet insertion hole 11 may also be a V-shape which is convex inward in the radial direction or convex outward in the radial direction in a plan view. Further, it is also possible to insert two or more permanent magnets 20 in each magnet insertion hole 11.

The permanent magnet 20 is a rare-earth magnet, for example. In the first embodiment, the permanent magnet 20 is a neodymium rare-earth magnet containing Nd (neodymium), Fe (iron) and B (boron), for example. The permanent magnet 20 is in the form of a plate, for example. In the first embodiment, the permanent magnet 20 is in the form of a flat plate. In the first embodiment, the permanent magnet 20 is in a rectangular shape in a plan view.

The plurality of permanent magnets 20 include magnetic poles having the same polarity as each other (for example, north poles) on their outer sides in the radial direction. Accordingly, magnet magnetic poles P1 formed by the permanent magnets 20 are formed in the rotor 1.

The plurality of permanent magnets 20 include magnetic poles having the same polarity as each other (for example, south poles) on their inner sides in the radial direction. Magnetic flux emitted from the inner side of the permanent magnet 20 in the radial direction flows into the second core part 22, by which a virtual magnetic pole P2 (for example, south pole) is formed on the outer side of the second core part 22 in the radial direction. Thus, the plurality of second core parts 22 form virtual magnetic poles P2 having the same polarity as each other on their outer sides in the radial direction.

The rotor 1 is a rotor of the consequent-pole type in which the magnet magnetic poles P1 and the virtual magnetic poles P2 are arranged alternately in the circumferential direction R1. In the rotor 1 of the consequent-pole type, the number of permanent magnets 20 can be reduced to half as compared to a rotor of a non-consequent-pole type having the same number of poles. Accordingly, the manufacturing cost of the rotor 1 is reduced. Incidentally, while the number of poles of the rotor 1 is 10 in the first embodiment, the number of poles is not limited to 10. It is sufficient that the number of poles is an even number greater than or equal to 4. Further, in the rotor 1, it is also possible that the magnet magnetic poles P1 are south poles and the virtual magnetic poles P2 are north poles.

In the following description, a straight line extending in the radial direction through the center of the magnet magnetic pole P1 in the circumferential direction R1 (i.e., pole center) is referred to as a “magnet magnetic pole center line M1”. In other words, the magnet magnetic pole center line M1 is a straight line extending in the radial direction through the center of the permanent magnet 20 in the circumferential direction R1. Further, a straight line extending in the radial direction through the center of the virtual magnetic pole P2 in the circumferential direction R1 (i.e., pole center) is referred to as a “virtual magnetic pole center line M2”.

The first core part 21 further includes a plurality of flux barriers 12 as leakage flux inhibition holes. The flux barrier 12 is formed on each side of the magnet insertion hole 11 in the circumferential direction R1. Since a portion 21c between the flux barrier 12 and the outer periphery 21b of the first core part 21 is formed as a thin wall, leakage flux between the magnet magnetic pole P1 and the virtual magnetic pole P2 adjoining each other is inhibited.

The second core part 22 includes a crimping portion 14. The crimping portion 14 is a crimping mark formed when the plurality of electromagnetic steel sheets 18 stacked in the axial direction (see FIG. 3) are fixed together by means of crimping. The crimping portion 14 is formed on an inner side of the second core part 22 in the radial direction. The shape of the crimping portion 14 as viewed in the axial direction is a circular shape, for example. The shape of the crimping portion 14 is not limited to the circular shape but may also be a different shape such as a rectangular shape.

### (Cavity Portion)

In the first core part 21, a cavity portion 15 is formed on the inner side in the radial direction relative to the permanent magnet 20 (i.e., the magnet insertion hole 11). The cavity portion 15 is an opening portion penetrating the stacked electromagnetic steel sheets 18 (see FIG. 3) in the axial direction. The cavity portion 15 includes a first portion 15a and a second portion 15b connected to the first portion 15a.

The width of the first portion 15a in the circumferential direction R1 increases toward the inner side in the radial direction. In other words, the width of the first portion 15a in the circumferential direction R1 increases toward the shaft 25 shown in FIG. 4. The shape of the first portion 15a as viewed in the axial direction is a semicircular shape, for example. The width of the second portion 15b in the circumferential direction R1 decreases toward the inner side in the radial direction. The shape of the second portion 15b as viewed in the axial direction is a semicircular shape, for example. Namely, in the first embodiment, the shape of the cavity portion 15 as viewed in the axial direction is a circular shape. The shape of the cavity portion 15 is not limited to the circular shape but may also be a different shape such as an elliptical shape.

A surface 15d facing outward in the radial direction and located on the innermost side of the cavity portion 15 in the radial direction is located on the inner side in the radial direction relative to a radial-direction-inner-end portion 22a of the second core part 22. The surface 15d facing outward in the radial direction is one of a plurality of surfaces defining the cavity portion 15. Incidentally, the radial-direction-inner-end portion 22a of the second core part 22 is an innermost portion of the second core part 22 in the radial direction. Specifically, the radial-direction-inner-end portion 22a of the second core part 22 is an inner peripheral surface of the second core part 22.

The cavity portion 15 is arranged at a position overlapping with the magnet magnetic pole center line M1. The cavity portion 15 has a shape that is symmetrical with respect to the magnet magnetic pole center line M1. In the first embodiment, a plurality of cavity portions 15 are formed in the rotor core 10. The plurality of cavity portions 15 are arranged at equal intervals in the circumferential direction.

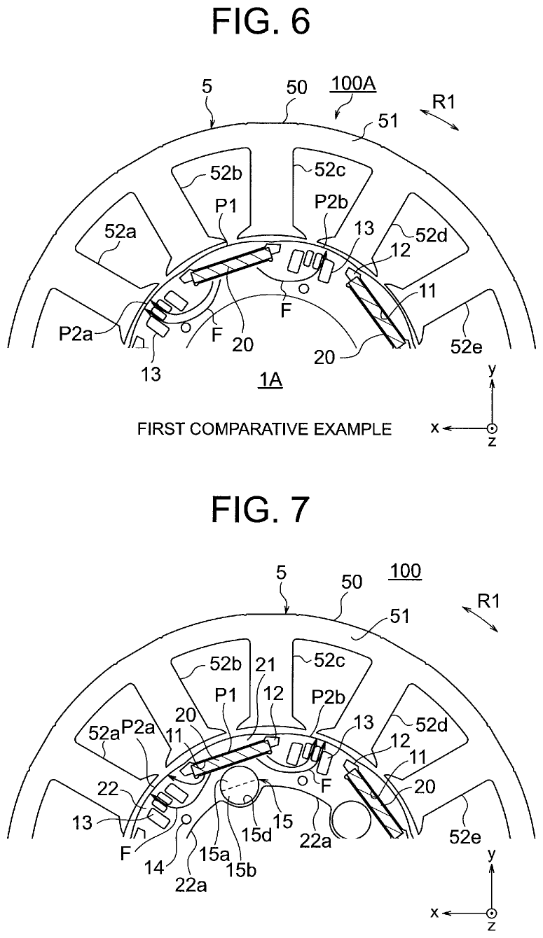

Next, the effect obtained by forming the cavity portions 15 will be described below while making a comparison with a first comparative example. FIG. 6 is a schematic diagram showing the flow of magnetic flux F in a rotor 1A of a motor 100A according to the first comparative example. FIG. 7 is a schematic diagram showing the flow of magnetic flux F in the rotor 1 according to the first embodiment. As shown in FIGS. 6 and 7, the rotor 1A according to the first comparative example differs from the rotor 1 according to the first embodiment in that the rotor 1 includes no cavity portions 15. Incidentally, in FIG. 6 and FIG. 7 which will be described later, a plurality of teeth extending inward in the radial direction from the yoke 51 of the stator core 50 are assigned reference characters 52a, 52b, 52c, 52d and 52e, and a plurality of virtual magnetic poles are assigned reference characters P2a and P2b.

As shown in FIG. 6, the magnetic flux F emitted from the inner side of the permanent magnet 20 in the radial direction flows into the virtual magnetic poles P2a and P2b through the first core part 21 and the second core parts 22. In the rotor 1A according to the first comparative example, no cavity portion (part corresponding to the cavity portion 15 shown in FIG. 7) is formed in the first core part 21. Thus, the distance for which the magnetic flux F emitted from the inner side of the permanent magnet 20 in the radial direction proceeds in the radial direction in the first core part 21 is long. Thus, in the first comparative example, the magnetic flux F emitted from the inner side of the permanent magnet 20 in the radial direction is more likely to flow into the second core part 22 while drawing a slight arc. Accordingly, in the first comparative example, among the magnetic flux F emitted from the inner side of the permanent magnet 20 in the radial direction, the amount of the magnetic flux F flowing into the second core part 22 decreases and the density of the magnetic flux F in the second core part 22 decreases.

In contrast, in the first embodiment shown in FIG. 7, the distance for which the magnetic flux F emitted from the inner side of the permanent magnet 20 in the radial direction proceeds in the radial direction in the first core part 21 is shorter than in the first comparative example. This is because the magnetic flux F emitted from the inner side of the permanent magnet 20 in the radial direction flows along the cavity portion 15 in the first core part 21 in the first embodiment. Specifically, since the cavity portion 15 includes the first portion 15a whose width in the circumferential direction R1 increases toward the shaft 25, the magnetic flux F emitted from the inner side of the permanent magnet 20 in the radial direction flows along the first portion 15a in the first core part 21. Accordingly, the magnetic flux F emitted from the inner side of the permanent magnet 20 in the radial direction is forcibly guided to the second core part 22. Namely, the flow of the magnetic flux F is rectified by the cavity portion 15. Accordingly, in the first embodiment, among the magnetic flux F emitted from the inner side of the permanent magnet 20 in the radial direction, the amount of the magnetic flux F flowing into the second core part 22 increases and the density of the magnetic flux F in the second core part 22 rises.

The surface 15d of the cavity portion 15 facing outward in the radial direction is located on the inner side in the radial direction relative to the radial-direction-inner-end portion 22a of the second core part 22. Thus, a length Lr from a surface 15c of the cavity portion 15 facing inward in the radial direction to the surface 15d facing outward in the radial direction, namely, the length in the radial direction of the cavity portion 15 guiding the magnetic flux F can be made longer.

Further, since the surface 15d of the cavity portion 15 facing outward in the radial direction is located on the inner side in the radial direction relative to the radial-direction-inner-end portion 22a of the second core part 22, the inner peripheral surface 17 (see FIG. 5) of the rotor core 10 has a concave/convex shape. Thus, the connection portion 30 made of the resin and the rotor core 10 engage with each other by concave/convex fitting as will be described later, which improves the transmissibility of torque from the rotor core 10 to the shaft 25 via the connection portion 30.

Further, in the first comparative example shown in FIG. 6, a case where an area at which the pole center of the virtual magnetic pole P2a faces the tooth 52a is larger than an area at which the pole center of the virtual magnetic pole P2b faces the tooth 52d is shown as an example. In this case, the magnetic flux F is more likely to flow into the second core part 22 forming the virtual magnetic pole P2a rather than into the second core part 22 forming the virtual magnetic pole P2b. Namely, in the rotor 1A according to the first comparative example, variation in the magnetic flux amount occurs between the virtual magnetic poles P2a and P2b. With such variation in the magnetic flux amount, there occurs a place where the difference in the surface magnetic flux density between the magnet magnetic pole P1 and the virtual magnetic pole P2 adjoining each other in the circumferential direction is great, and thus vibration and noise is more likely to occur.

In contrast, in the first embodiment shown in FIG. 7, the cavity portion 15 is arranged at a position overlapping with the magnet magnetic pole center line M1 (see FIG. 5) and has a shape symmetrical with respect to the magnet magnetic pole center line M1. Thus, the magnetic flux F emitted from the inner side of the permanent magnet 20 in the radial direction is more likely to evenly flow into the second core parts 22 located on both sides in the circumferential direction R1 with respect to the permanent magnet 20. Accordingly, in the first embodiment, the variation in the magnetic flux amount between the virtual magnetic poles P2a and P2b hardly occurs.

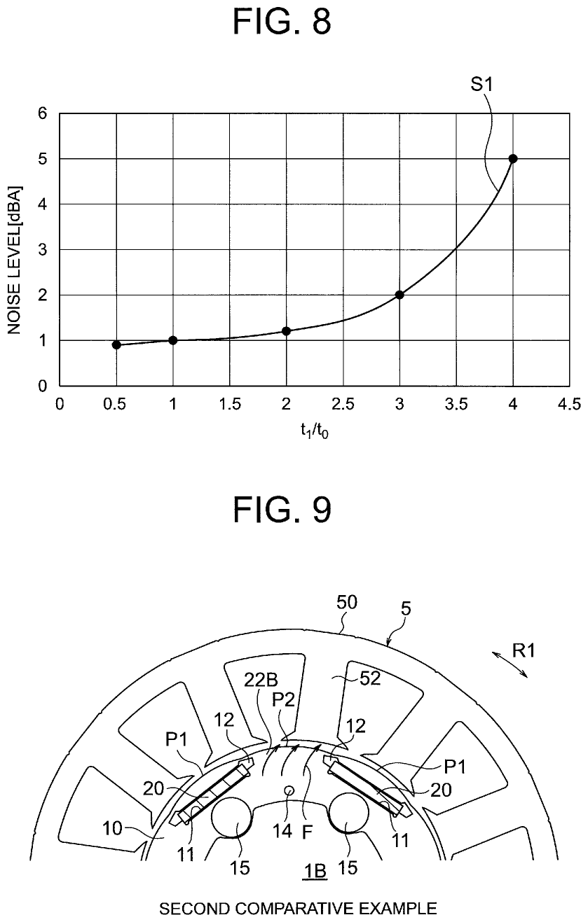

Next, a description will be given of a relationship between the thickness of a portion (hereinafter referred to also as a “bridge portion”) 16 between the cavity portion 15 and the magnet insertion hole 11 and the noise occurring in the motor 100 during rotation, with reference to FIGS. 5 and 8. To reduce the noise of the motor 100, that is, to inhibit the occurrence of the variation in the magnetic flux amount between the virtual magnetic poles P2a and P2b shown in FIG. 7, the thickness of the bridge portion 16 is desired to be small. In the following description, the thickness of the bridge portion 16 is assigned a reference character t₁, and a ratio t₁/t₀ of the thickness t₁ of the bridge portion 16 to the sheet thickness t₀ of one electromagnetic steel sheet 18 is used.

FIG. 8 is a graph showing a relationship S1 between the ratio t₁/t₀ and the noise level of the motor 100. In FIG. 8, the horizontal axis represents the ratio t₁/t₀ and the vertical axis represents a detection value of the noise level [dBA] of the motor 100.

As shown in FIG. 8, in a range where the ratio t₁/t₀ is lower than or equal to 3, the noise level of the motor 100 is less than or equal to 2 dBA even though the noise level of the motor 100 rises gradually. However, in a range where the ratio t₁/t₀ is higher than or equal to 3, the noise level of the motor 100 rises sharply. Namely, the noise level of the motor 100 can be maintained in a permissible range when an upper limit of the ratio t₁/t₀ is lower than or equal to 3.

Here, the rotor 1 includes a plurality of electromagnetic steel sheets 18 stacked in the axial direction (see FIG. 3) as described above, but the magnet insertion hole 11 and the cavity portion 15 are previously formed in each electromagnetic steel sheet 18 by stamping processing. Normally, in order to form the bridge portion 16 between the magnet insertion hole 11 and the cavity portion 15 in the stamping processing of the electromagnetic steel sheet 18, the thickness t₁ of the bridge portion 16 needs to be 0.5 times or more of the sheet thickness t₀ of one electromagnetic steel sheet 18, for example. Namely, in general, the bridge portion 16 can be formed by the stamping processing when a lower limit of the ratio t₁/t₀ is higher than or equal to 0.5.

Thus, the ratio t₁/t₀ of the thickness t₁ of the bridge portion 16 to the sheet thickness t₀ of one electromagnetic steel sheet 18 is desired to satisfy the following expression (1):

0.5≤t₁/t₀≤3 (1)

When the ratio t₁/t₀ satisfies the following expression (2), it is possible to maintain the noise level of the motor 100 in the permissible range while enabling the formation of the bridge portion 16 by the stamping processing, and thus the ratio t₁/t₀ satisfying the following expression (2) is more desirable:

0.5≤t₁/t₀≤2 (2)

### (Projecting Portion)

As shown in FIGS. 4 and 5, the first core part 21 further includes a projecting portion 21a on its inner side in the radial direction. The shape of the projecting portion 21a as viewed in the axial direction is an arc shape. The projecting portion 21a projects inward in the radial direction relative to the radial-direction-inner-end portion 22a of the second core part 22. In other words, the radial-direction-inner-end portion 22a of the second core part 22 is a concave portion located on the outer side in the radial direction relative to the projecting portion 21a. Thus, the inner peripheral surface 17 of the rotor core 10 is formed in the concave-convex shape by the projecting portions 21a and the radial-direction-inner-end portions 22a. Since the radial-direction-inner-end portion 22a of the second core part 22 is formed as a concave portion, a part of the second core part 22 unnecessary for the flow of the magnetic flux F is removed. Thus, the weight of the motor 1 can be reduced, and the manufacturing cost of the rotor 1 can be reduced.

As shown in FIG. 4, the outer cylinder portion 33 of the connection portion 30 in contact with the inner peripheral surface 17 of the rotor core 10 includes the concave portions 33a that engage with the projecting portions 21a and convex portions 33b that engage with the radial-direction-inner-end portions 22a. With this configuration, the transmissibility of torque from the rotor core 10 to the shaft 25 via the connection portion 30 is improved.

### (Slits)

Next, slits provided in the second core part 22 will be described below. In the first embodiment, the second core part 22 includes two first slits 13a and two second slits 13b, for example. The first slits 13a and the second slits 13b penetrate the stacked electromagnetic steel sheets 18 (see FIG. 3) in the axial direction.

A plurality of first slits 13a are arranged on both sides of the virtual magnetic pole center line M2 in the circumferential direction R1. The plurality of first slits 13a are arranged symmetrically with respect to the virtual magnetic pole center line M2. A plurality of second slits 13b are respectively arranged on both sides of the plurality of first slits 13a in the circumferential direction R1. The plurality of second slits 13b are arranged symmetrically with respect to the virtual magnetic pole center line M2. In the following description, when it is unnecessary to distinguish between the first slits 13a and the second slits 13b, the first slits 13a and the second slits 13b will be collectively referred to as “slits 13”.

The slits 13 are located on the outer side in the radial direction relative to the crimping portion 14. Each slit 13 has a shape elongated in the radial direction. Namely, the length of the slit 13 in the radial direction is greater than the width of the slit 13 in the circumferential direction R1. Incidentally, the slit 13 is not limited to the shape elongated in the radial direction but may also be in a different shape such as a circular shape.

In the first embodiment, each slit 13 is filled with a resin material (for example, PBT) which is not illustrated. The slit 13 is not necessarily filled with the resin material. Further, it is sufficient that the second core part 22 includes at least one slit 13.

Next, the effect obtained by providing the second core part 22 with the slit 13 will be described below while making a comparison with a second comparative example. FIG. 9 is a schematic diagram showing the flow of magnetic flux F in a second core part 22B of a rotor 1B according to the second comparative example. The rotor 1B according to the second comparative example differs from the rotor 1 according to the first embodiment in that no slits 13 are formed in the second core part 22B.

As shown in FIG. 9, in the second core part 22B in the second comparative example, as the magnetic flux F proceeds from the inner side toward the outer side in the radial direction, the magnetic flux F is inclined toward the tooth 52 facing the virtual magnetic pole P2. In this case, among the magnetic flux F flowing in the second core part 22, the amount of the magnetic flux F flowing into the pole center of the virtual magnetic pole P2 decreases.

In contrast, in the first embodiment, the slits 13 are formed in the second core part 22 as shown in FIG. 7, and thus the magnetic flux F flowing in the second core part 22 from the inner side toward the outer side in the radial direction flows along the slits 13 in a direction parallel to the radial direction. Namely, since the slits 13 are formed in the second core part 22, the flow of the magnetic flux in the second core part 22 can be rectified in the direction parallel to the radial direction. This makes it possible to concentrate the magnetic flux F flowing in the second core part 22 on the pole center of the virtual magnetic pole P2. Accordingly, the difference between the surface magnetic flux density of the magnet magnetic pole P1 and the surface magnetic flux density of the virtual magnetic pole P2 can be reduced, and the vibration and the noise in the motor 100 can be reduced.

### (Other Configurations in Rotor)

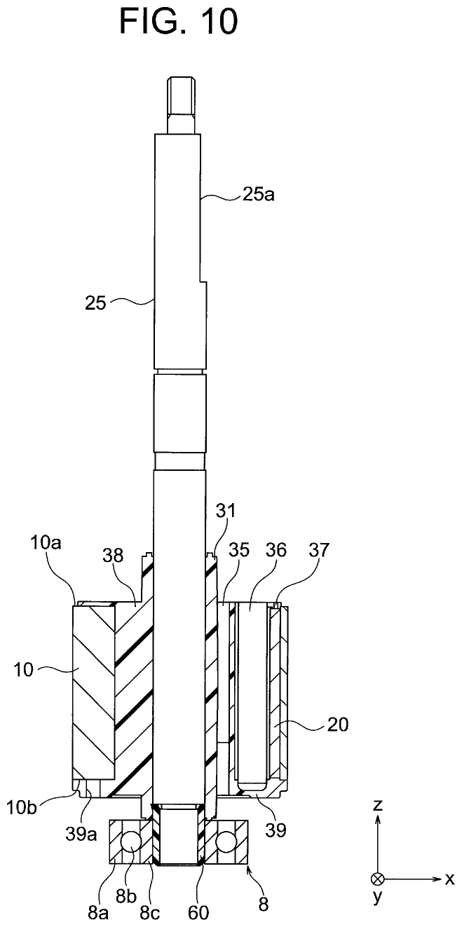

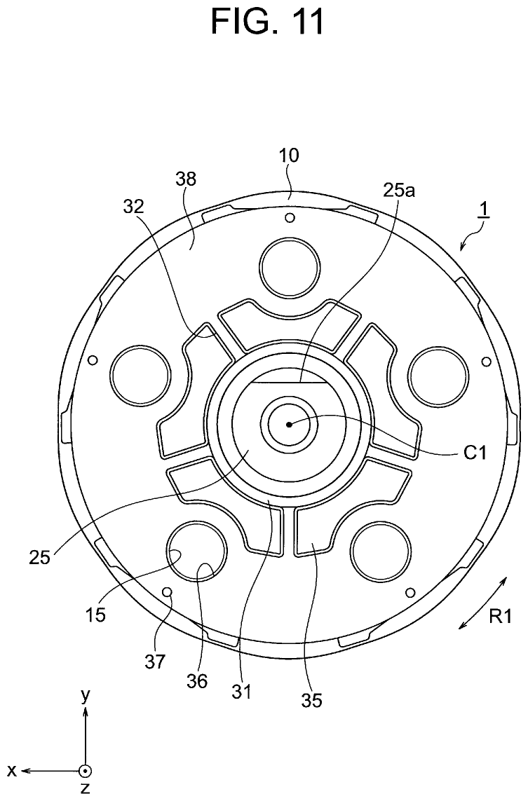

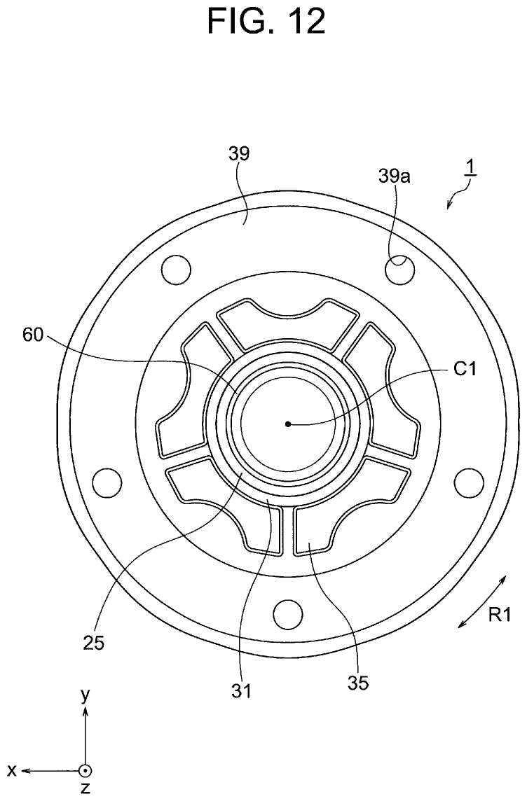

Next, other configurations of the rotor 1 will be described below with reference to FIGS. 10 to 12. FIG. 10 is a sectional view showing the configuration of the rotor 1. FIG. 11 is a plan view of the rotor 1 shown in FIG. 10 as viewed from the +z-axis side. FIG. 12 is a plan view of the rotor 1 shown in FIG. 10 as viewed from the −z-axis side. As shown in FIGS. 10 to 12, the connection portion 30 of the rotor 1 further includes a first end face portion 38 that covers an end face of the rotor core 10 on the +z-axis side and a second end face portion 39 that covers an end face of the rotor core 10 on the −z-axis side. The first end face portion 38 and the second end face portion 39 are connected to the inner cylinder portion 31, the ribs 32 and the outer cylinder portion 33 shown in FIG. 4. Incidentally, the first end face portion 38 and the second end face portion 39 do not need to entirely cover the end faces of the rotor core 10 but may cover at least part of the end faces of the rotor core 10.

As shown in FIG. 11, the first end face portion 38 includes openings 36 through which the cavity portions 15 are exposed and magnet exposure holes 37 through which parts of the permanent magnets 20 are exposed. As shown in FIGS. 10 and 12, the second end face portion 39 includes openings 39a through which an end face 10b of the rotor core 10 on the −z-axis side is exposed.

As shown in FIG. 10, the rotor 1 may further include the insulation sleeve 60 as an insulation member. The insulation sleeve 60 is arranged between the end portion 25b of the shaft 25 on the −z-axis side and the second bearing 8. The insulation sleeve 60 is in a substantially cylindrical shape, for example. The insulation sleeve 60 is formed of a thermosetting resin, for example. In the first embodiment, the insulation sleeve 60 is formed of BMC resin.

Next, the effect of providing the rotor 1 with the connection portion 30 and the insulation sleeve 60 will be described below while making a comparison with a third comparative example. Specifically, prevention of the flow of shaft current to the first bearing 7 and the second bearing 8 will be described below while making a comparison with the third comparative example.

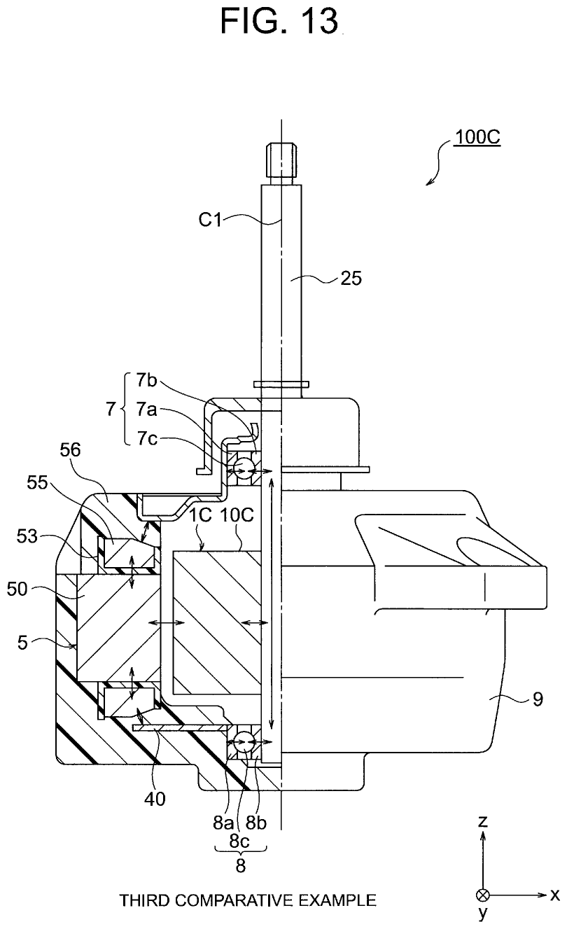

FIG. 13 is a diagram showing the flow of the shaft current in a motor 100C according to the third comparative example with bidirectional arrows. Incidentally, a rotor 1C of the motor 100C according to the third comparative example differs from the rotor 1 according to the first embodiment in that the rotor 1C includes a rotor core 10C directly fixed to the shaft 25 and includes no insulation sleeve 60.

In the motor 100C according to the third comparative example, when the carrier frequency of the inverter is increased in order to compensate for decreases in the output power and the efficiency of the motor 100C or the like, the current value of the shaft current flowing into the shaft 25 of the rotor 1C increases. In this case, the shaft current flows between the shaft 25 and the rotor core 10C and thereafter circulates the stator 5, the mold resin portion 56, the first bearing 7 (or the second bearing 8) and the shaft 25, in this order. When the shaft current flows into the first bearing 7 and the second bearing 8, corrosion called electrolytic corrosion may occur on orbital surfaces of outer rings 7a and 8a and inner rings 7b and 8b and rolling surfaces of rolling bodies 7c and 8c.

In contrast, in the first embodiment, the connection portion 30 formed of a resin material having an electrical insulation property is arranged between the shaft 25 and the rotor core 10 as shown in FIG. 10 described above. With this configuration, even when the carrier frequency of the inverter is increased in the motor 100 according to the first embodiment, the flow of the shaft current between the shaft 25 and the rotor core 10 is prevented, and thus the flow of the shaft current into the first bearing 7 and the second bearing 8 is prevented. Accordingly, in the first embodiment, the occurrence of the electrolytic corrosion of the first bearing 7 and the second bearing 8 is prevented.

In the third comparative example shown in FIG. 13, when the carrier frequency of the inverter is increased, there is also a case where the shaft current flows through a path formed by the shaft 25, the second bearing 8, the mold resin portion 56, the stator 5, the bracket 6 and the first bearing 7. Also in this case, the electrolytic corrosion of the first bearing 7 and the second bearing 8 may occur.

In contrast, in the first embodiment, the insulation sleeve 60 as the insulation member is arranged between the end portion 25b of the shaft 25 and the second bearing 8 as shown in FIG. 10. With this arrangement, in the motor 100 according to the first embodiment, the flow of the shaft current between the shaft 25 and the second bearing 8 is prevented, and thus the flow of the shaft current into the second bearing 8 is prevented. Further, by the prevention of the flow of the shaft current into the second bearing 8, the flow of the shaft current into the first bearing 7 is prevented. Accordingly, the occurrence of the electrolytic corrosion of the first bearing 7 and the second bearing 8 is prevented.

Incidentally, it is also possible to arrange the insulation sleeve 60 between the shaft 25 and the first bearing 7, or both between the shaft 25 and the first bearing 7 and between the shaft 25 and the second bearing 8.

### (Manufacturing Method of Rotor)

Next, a manufacturing method of the rotor 1 will be described below. The rotor 1 is manufactured by the integral molding of the rotor core 10 to which the permanent magnets 20 are attached, the shaft 25 and the insulation sleeve 60.

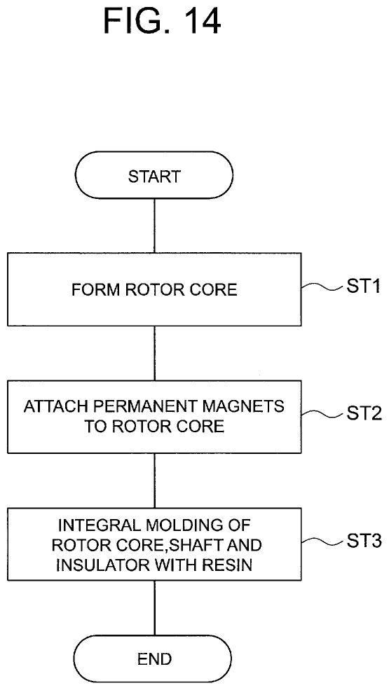

FIG. 14 is a flowchart showing the manufacturing method of the rotor 1. First, in step ST1, the rotor core 10 is formed. The rotor core 10 including the first core parts 21 having the above-described cavity portions 15 and the second core parts 22 is formed. Specifically, the rotor core 10 is formed by stacking a plurality of electromagnetic steel sheets 18 (see FIG. 3), each of which includes the first core parts 21 having the cavity portions 15 and the second core parts 22, in the axial direction and fixing the stacked electromagnetic steel sheets 18 together by means of crimping or the like.

In step ST2, the permanent magnets 20 are attached to the rotor core 10 by inserting the permanent magnets 20 into the magnet insertion holes 11 of the first core parts 21.

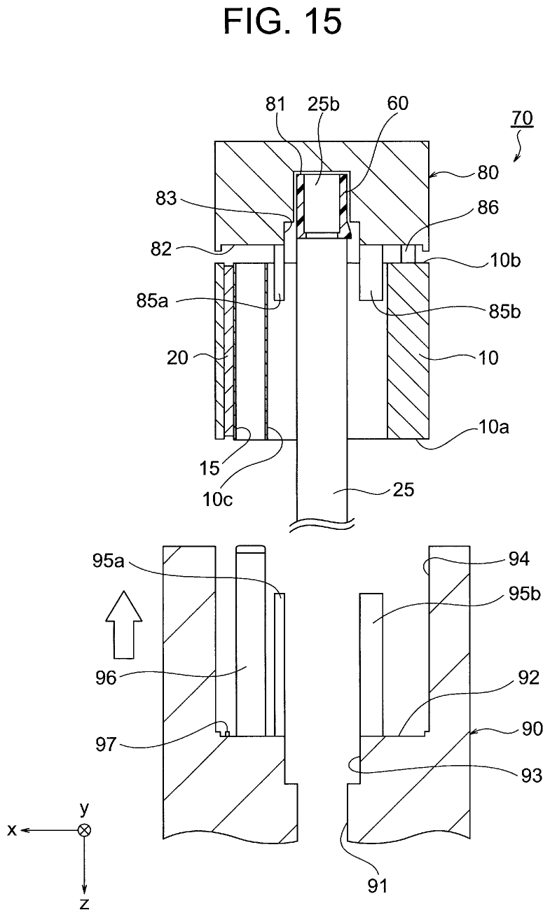

In step ST3, the rotor core 10 to which the permanent magnets 20 are attached, the shaft 25 and the insulation sleeve 60 are set in a mold 70 (see FIG. 15 which will be described later) and a resin is injected into the mold 70. Thus, the rotor core 10 to which the permanent magnets 20 are attached, the shaft 25 and the insulation sleeve 60 are integrally formed. Incidentally, the shaft 25 and the insulation sleeve 60 are prepared before the step ST1.

FIG. 15 is a sectional view showing the configuration of the mold 70 used in the step ST3 of the manufacturing process of the rotor 1 shown in FIG. 14. As shown in FIG. 15, the mold 70 includes a fixed mold (i.e., upper mold) 80 and a movable mold (i.e., lower mold) 90.

The fixed mold 80 includes an insertion hole 81, a facing portion 82, a cylinder portion 83, a plurality of hollow forming portions 85a and 85b, and a core retainer portion 86. The end portion 25b of the shaft 25 on the −z-axis side to which the insulation sleeve 60 is attached is inserted into the insertion hole 81. The facing portion 82 makes contact with the end face 10b of the rotor core 10 on the −z-axis side. The cylinder portion 83 faces an outer periphery of the insulation sleeve 60. The plurality of hollow forming portions 85a and 85b are inserted into the hollow portion 10c of the rotor core 10. The core retainer portion 86 projects from the facing portion 82 toward the movable mold 90 side and makes contact with the end face 10b of the rotor core 10 on the −z-axis side. By the contact of the core retainer portion 86 with the end face 10b of the rotor core 10, a gap is formed between the end face 10b of the rotor core 10 and the facing portion 82.

The movable mold 90 includes a shaft insertion hole 91, a facing portion 92, a cylinder portion 93, a core insertion portion 94 and a plurality of hollow forming portions 95a and 95b. The shaft 25 is inserted into the shaft insertion hole 91. The facing portion 92 makes contact with an end face 10a of the rotor core 10 on the +z-axis side. The cylinder portion 93 faces the outer periphery of the shaft 25. The outer periphery of the rotor core 10 makes contact with the core insertion portion 94. The plurality of hollow forming portions 95a and 95b are inserted into the hollow portion 10c of the rotor core 10.

The movable mold 90 further includes core positioning portions 96 and magnet receiving portions 97. The core positioning portions 96 and the magnet receiving portions 97 project from the facing portion 92 toward the fixed mold 80. Each core positioning portion 96 is inserted into the cavity portion 15 of the rotor core 10 and thereby functions as a portion for positioning the rotor core 10 at the time of the integral molding. Each magnet receiving portion 97 makes contact with an end face of the permanent magnet 20 on the +z-axis side and thereby functions as a portion for positioning the permanent magnet 20 at the time of the integral molding.

When the movable mold 90 ascends in the direction of the arrow shown in FIG. 15, the hollow forming portions 85a and 85b of the fixed mold 80 respectively make contact with the hollow forming portions 95a and 95b of the movable mold 90. At that time, a gap is formed between the end face 10b of the rotor core 10 and the facing portion 82 of the fixed mold 80. When molten resin is injected into the mold 70 through a gate (not shown), the resin fills gaps between the rotor core 10 and the shaft 25, between the insulation sleeve 60 and the cylinder portion 83, and between the shaft 25 and the cylinder portion 93. Further, the resin also fills gaps between the end face 10b of the rotor core 10 and the facing portion 82 and between the end face 10a of the rotor core 10 and the facing portion 92. Furthermore, the resin also fills gaps between the magnet insertion holes 11 (see FIG. 5) and the permanent magnets 20 and also fills the slits 13 (see FIG. 5) of the second core parts 22.

After the resin is injected into the mold 70, the mold 70 is cooled down. Accordingly, the resin is hardened and the connection portion 30 is formed. Specifically, the resin hardened between the insulation sleeve 60 and the cylinder portion 83 and between the shaft 25 and the cylinder portion 93 turns into the inner cylinder portion 31 (see FIG. 10). The resin hardened in the hollow portion 10c (except for portions where the hollow forming portions 85a, 85b, 95a and 95b are inserted) on the inner side of the rotor core 10 in the radial direction turns into the inner cylinder portion 31, the plurality of ribs 32 and the outer cylinder portion 33 (see FIG. 4). Portions corresponding to the hollow forming portions 85a, 85b, 95a and 95b of the mold 70 turn into the hollow portions 35 (see FIG. 4). Further, the resin hardened between the end face 10a of the rotor core 10 and the facing portion 92 turns into the first end face portion 38 (see FIG. 10 or 11) and the resin hardened between the end face 10b of the rotor core 10 and the facing portion 82 turns into the second end face portion 39 (see FIG. 10 or 12).

Thereafter, the movable mold 90 is lowered and the rotor 1 is taken out of the fixed mold 80. With the above process, the manufacture of the rotor 1 is completed.

### Effect of First Embodiment

With the rotor 1 according to the first embodiment described above, the following effects are obtained.

In the rotor 1, the cavity portion 15 of the first core part 21 includes the first portion 15a whose width in the circumferential direction R1 increases toward the inner side in the radial direction. With this configuration, the magnetic flux F emitted from the inner side of the permanent magnet 20 in the radial direction flows along the first portion 15a in the first core part 21 and is forcibly guided to the second core part 22. Further, since the surface 15d of the cavity portion 15 facing outward in the radial direction is located on the inner side in the radial direction relative to the radial-direction-inner-end portion 22a of the second core part 22, the length in the radial direction of the cavity portion 15 guiding the magnetic flux F can be made long. Accordingly, the magnetic flux F emitted from the inner side of the permanent magnet 20 in the radial direction is more likely to be guided to the second core part 22. Thus, according to the first embodiment, among the magnetic flux F emitted from the permanent magnet 20, the amount of the magnetic flux F flowing into the second core part 22 increases. Due to the increase in the amount of the magnetic flux F flowing into the second core part 22, variation in the surface magnetic flux density between the magnet magnetic pole P1 and the virtual magnetic pole P2 is reduced, and thus the vibration and the noise of the motor 100 can be reduced.

According to the first embodiment, the surface 15d facing outward in the radial direction and located on the innermost side of the cavity portion 15 in the radial direction is located on the inner side in the radial direction relative to the radial-direction-inner-end portion 22a of the second core part 22. Thus, the inner peripheral surface 17 of the rotor core 10 can be formed in the concave-convex shape. Accordingly, the rotor core 10 and the connection portion 30 engage with each other by the concave/convex fitting, which improves the transmissibility of torque from the rotor core 10 to the shaft 25 via the connection portion 30. Especially, even when neodymium rare-earth magnets having strong magnetic force are used as the permanent magnets 20, the transmissibility of torque to the shaft 25 is improved.

According to the first embodiment, the first core part 21 includes the projecting portion 21a that engages with the concave portion 33a of the connection portion 30. With this configuration, the projecting portion 21a can be made to function as a torque transmission portion that transmits torque to the shaft 25 via the connection portion 30, by which the transmissibility of the torque of the rotor 1 to the shaft 25 via the connection portion 30 is improved.

According to the first embodiment, the cavity portion 15 includes the second portion 15b whose width in the circumferential direction R1 decreases toward the inner side in the radial direction. With this configuration, the shape of the first core part 21 on the inner side in the radial direction can be reduced in size. Accordingly, the weight of the rotor core 10 decreases, so that the cost for the rotor 1 can be reduced and the weight of the rotor 1 can be reduced.

According to the first embodiment, since the shape of the cavity portion 15 as viewed in the axial direction is a circular shape, the cavity portion 15 can be easily formed in the electromagnetic steel sheets 18 by the stamping processing using a pressing die.

According to the first embodiment, the ratio t₁/t₀ of the thickness t₁ of the bridge portion 16 to the sheet thickness t₀ of one electromagnetic steel sheet 18 satisfies 0.5≤t₁/t₀≤3. This makes it possible to maintain the noise level of the motor 100 in the permissible range while enabling the formation of the bridge portion 16 by the stamping processing.

According to the first embodiment, the ratio t₁/t₀ satisfies 0.5≤t₁/t₀≤2. This makes it possible to maintain the noise level of the motor 100 in the permissible range while enabling the formation of the bridge portion 16 by the stamping processing.

According to the first embodiment, the second core part 22 includes the slit 13. With this configuration, the direction of the magnetic flux F flowing in the second core part 22 can be rectified in the direction parallel to the radial direction.

According to the first embodiment, the slit 13 is filled with a resin material, by which the strength of the rotor 1 is increased and deformation of the rotor 1 during the rotation can be prevented.

According to the first embodiment, at the time of the integral molding, the core positioning portion 96 of the movable mold 90 is inserted into the cavity portion 15. Namely, the cavity portion 15 is used to prevent displacement of the rotor core 10 at the time of the integral molding. Thus, in the rotor core 10, it is unnecessary to form another hole into which the core positioning portion 96 is to be inserted. Accordingly, the manufacturing cost of the rotor 1 can be reduced while securing satisfactory strength of the rotor 1.

According to the first embodiment, the magnet receiving portion 97 of the movable mold 90 is in contact with the permanent magnet 20 at the time of the integral molding. Accordingly, displacement of the permanent magnet 20 at the time of the integral molding can be prevented.

According to the first embodiment, a resin material is filled between the magnet insertion hole 11 and the permanent magnet 20. With this configuration, displacement of the permanent magnet 20 in the magnet insertion hole 11 during the rotation can be prevented.

According to the first embodiment, the connection portion 30 is formed of a resin material having the electrical insulation property. This makes it possible to electrically insulate between the rotor core 10 and the shaft 25 and prevent the flow of the shaft current into the first bearing 7 and the second bearing 8. Accordingly, the occurrence of the electrolytic corrosion of the first bearing 7 and the second bearing 8 can be prevented.

According to the first embodiment, the insulation sleeve 60 is arranged between the end portion 25b of the shaft 25 on the −z-axis side and the second bearing 8. This makes it possible to electrically insulate between the shaft 25 and the second bearing 8 and prevent the flow of the shaft current into the first bearing 7 and the second bearing 8. Accordingly, the occurrence of the electrolytic corrosion of the first bearing 7 and the second bearing 8 can be prevented.

According to the first embodiment, the insulation sleeve 60 is formed of BMC resin. Accordingly, satisfactory dimensional accuracy of the insulation sleeve 60 can be secured and the manufacturing cost of the insulation sleeve 60 can be reduced.

### Second Embodiment

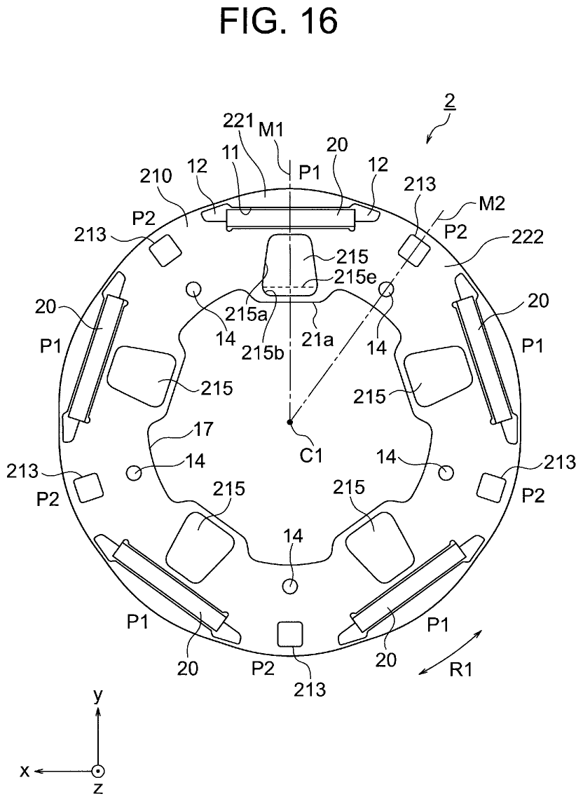

FIG. 16 is a plan view showing a rotor core 210 and permanent magnets 20 of a rotor 2 according to a second embodiment. In FIG. 16, components identical or corresponding to components shown in FIG. 5 are assigned the same reference characters as in FIG. 5. The rotor 2 differs from the rotor 1 according to the first embodiment in the shape of a cavity portion 215 and the configuration of a slit 213.

As shown in FIG. 16, the rotor core 210 of the rotor 2 according to the second embodiment includes first core parts 221 and second core parts 222 arranged to adjoin each other in the circumferential direction R1. The first core part 221 includes the cavity portion 215 formed on the inner side in the radial direction relative to the permanent magnet 20. The cavity portion 215 includes a first portion 215a whose width in the circumferential direction R1 increases from the outer side toward the inner side in the radial direction and a second portion 215b connected to the first portion 215a. The shape of the first portion 215a as viewed in the axial direction is a substantially trapezoidal shape. An innermost position 215e of the first portion 215a in the radial direction is located on the inner side in the radial direction relative to the crimping portion 14 of the second core part 222.

The second core part 222 includes one slit 213 formed on the outer side in the radial direction relative to the crimping portion 14. The shape of the slit 213 as viewed in the axial direction is a square shape, for example. Incidentally, the shape of the slit 213 is not limited to the square shape but may also be a different shape such as a rectangular shape. Further, the number of slits 213 is not limited to one but may also be a plural number.

### Effect of Second Embodiment

According to the second embodiment described above, the cavity portion 215 includes the first portion 215a in a substantially trapezoidal shape whose width in the circumferential direction R1 increases toward the inner side in the radial direction. With this configuration, the magnetic flux emitted from the inner side of the permanent magnet 20 in the radial direction flows along the first portion 215a in the first core part 221 and is forcibly guided to the second core part 222. Accordingly, among the magnetic flux emitted from the inner side of the permanent magnet 20 in the radial direction, the amount of the magnetic flux flowing into the second core part 222 increases.

Further, according to the second embodiment, the innermost position 215e of the first portion 215a of the cavity portion 215 in the radial direction is located on the inner side in the radial direction relative to an innermost position of the crimping portion 14 of the second core part 222, and the length in the radial direction of the first portion 215a is long. With this configuration, the distance for which the magnetic flux proceeds along the first portion 215a is long, and thus the magnetic flux emitted from the inner side of the permanent magnet 20 in the radial direction is more likely to be guided to the second core part 222. Accordingly, the amount of the magnetic flux flowing into the second core part 222 can be increased further.

Furthermore, according to the second embodiment, the second core part 222 includes the slit 213. With this configuration, the direction of the magnetic flux F flowing in the second core part 222 can be rectified in the direction parallel to the radial direction.

Moreover, according to the second embodiment, one slit 213 is formed in the second core part 222, and thus the work of processing the rotor core 210 is facilitated.

Except for the above-described features, the second embodiment is the same as the first embodiment.

### Third Embodiment

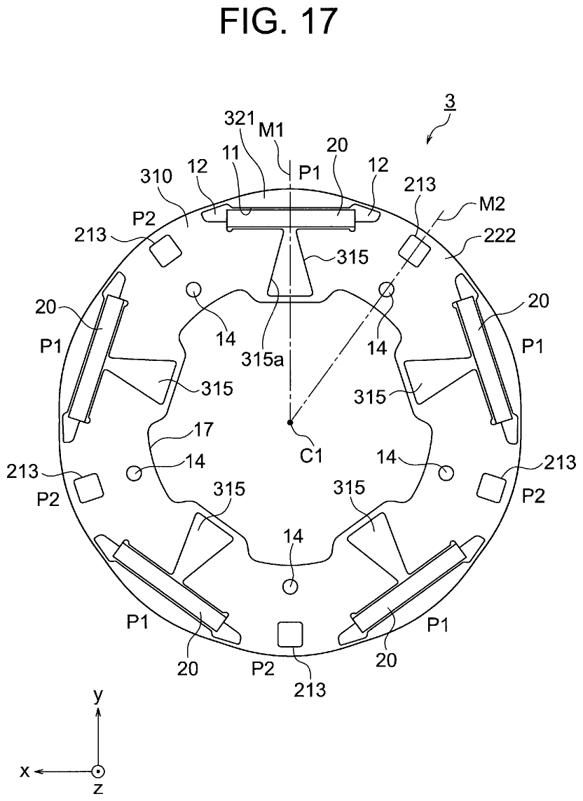

FIG. 17 is a plan view showing a rotor core 310 and permanent magnets 20 of a rotor 3 according to a third embodiment. In FIG. 17, components identical or corresponding to components shown in FIG. 5 or FIG. 16 are assigned the same reference characters as in FIG. 5 or FIG. 16. The rotor 3 differs from the rotor 1 or 2 according to the first or second embodiment in the shape of a cavity portion 315.

As shown in FIG. 17, the rotor core 310 of the rotor 3 according to the third embodiment includes first core parts 321 and the second core parts 222 arranged to adjoin each other in the circumferential direction R1. The first core part 321 includes the cavity portion 315 formed on the inner side in the radial direction relative to the permanent magnet 20. The cavity portion 315 is connected to the magnet insertion hole 11. A part of the cavity portion 315 on the outer side in the radial direction is connected to a part of the magnet insertion hole 11 on the inner side in the radial direction. Namely, in the rotor core 310 in the third embodiment, no portion corresponding to the bridge portion 16 (see FIG. 5) in the first embodiment is formed between the magnet insertion hole 11 and the cavity portion 315.

Further, the cavity portion 315 includes a first portion 315a whose width in the circumferential direction R1 increases from the outer side toward the inner side in the radial direction. However, the cavity portion 315 includes no portion corresponding to the second portion 15b of the cavity portion 15 in the rotor 1 in the first embodiment or the second portion 215b of the cavity portion 215 in the rotor 2 in the second embodiment.

### Effect of Third Embodiment

According to the third embodiment described above, the cavity portion 315 includes the first portion 315a whose width in the circumferential direction R1 increases from the outer side toward the inner side in the radial direction. With this configuration, the magnetic flux emitted from the inner side of the permanent magnet 20 in the radial direction flows in the first core part 321 along the first portion 315a and is forcibly guided to the second core part 222. Accordingly, among the magnetic flux emitted from the inner side of the permanent magnet 20 in the radial direction, the amount of the magnetic flux flowing into the second core part 222 increases.

Since the cavity portion 315 is connected to the magnet insertion hole 11, the magnetic flux emitted from the inner side of the permanent magnet 20 in the radial direction is more likely to proceed along the cavity portion 315 in the first core part 321. Accordingly, the magnetic flux emitted from the inner side of the permanent magnet 20 in the radial direction is more likely to flow into the second core part 222 along the cavity portion 315, and thus the amount of the magnetic flux flowing into the second core part 222 can be increased further.

Further, according to the third embodiment, since the cavity portion 315 is connected to the magnet insertion hole 11, the cavity portion 315 and the magnet insertion hole 11 can be formed at the same time in the process of forming the rotor core 310, and thus the process of processing the rotor 3 is simplified.

Except for the above-described features, the third embodiment is the same as the first or second embodiment.

### Fourth Embodiment

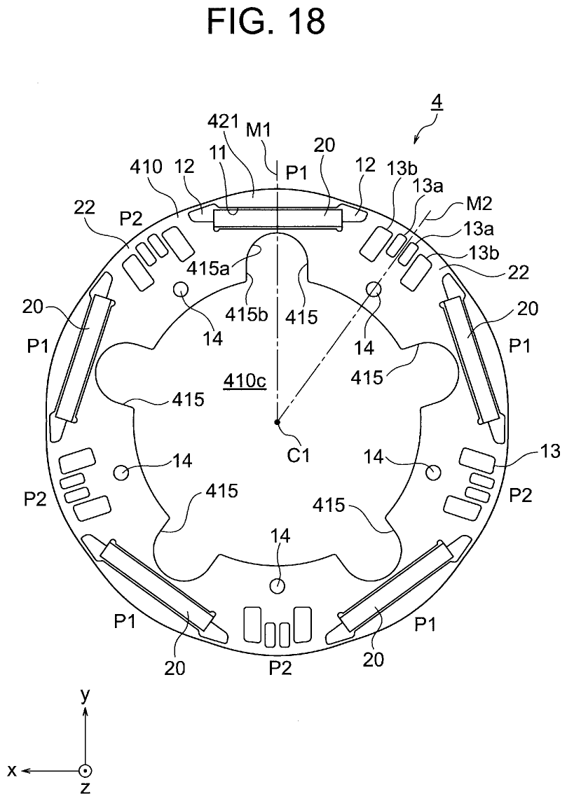

FIG. 18 is a plan view showing a rotor core 410 and permanent magnets 20 of a rotor 4 according to a fourth embodiment. In FIG. 18, components identical or corresponding to components shown in FIG. 5 are assigned the same reference characters as in FIG. 5. The rotor 4 differs from the rotor 1 according to the first embodiment in the shape of a cavity portion 415.

As shown in FIG. 18, the rotor core 410 of the rotor 4 according to the fourth embodiment includes first core parts 421 and the second core parts 22 arranged to adjoin each other in the circumferential direction R1. The first core part 421 includes the cavity portion 415 formed on the inner side in the radial direction relative to the permanent magnet 20. The cavity portion 415 is connected to a hollow portion 410c of the rotor core 410. Namely, no boundary portion exists between the cavity portion 415 and the hollow portion 410c in the fourth embodiment. The outer cylinder portion of the connection portion 30 (see FIG. 4) engages with the cavity portions 415. With this configuration, the rotor core 410 and the shaft 25 (see FIG. 4) are connected to each other. In the fourth embodiment, the cavity portions 415 engage with convex portions provided on the outer cylinder portion of the connection portion 30, for example.

The cavity portion 415 includes a first portion 415a whose width in the circumferential direction R1 increases toward the inner side in the radial direction and a second portion 415b connected to the first portion 415a. The second portion 415b is formed on the inner side in the radial direction relative to the first portion 415a. The width of the second portion 415b in the circumferential direction R1 is constant in the radial direction. However, the width of the second portion 415b in the circumferential direction R1 may also increase or decrease toward the inner side in the radial direction.

### Effect of Fourth Embodiment

According to the fourth embodiment described above, the cavity portion 415 includes the first portion 415a whose width in the circumferential direction R1 increases toward the inner side in the radial direction. With this configuration, the magnetic flux emitted from the inner side of the permanent magnet 20 in the radial direction flows along the first portion 415a in the first core part 421 and is forcibly guided to the second core part 22. Accordingly, in the magnetic flux emitted from the inner side of the permanent magnet 20 in the radial direction, the amount of the magnetic flux flowing into the second core part 22 increases.

Further, according to the fourth embodiment, the cavity portion 415 does not have the surface facing outward in the radial direction and located on the innermost side in the radial direction. The cavity portion 415 is connected to the hollow portion 410c of the rotor core 410. With this configuration, the weight of the rotor core 410 decreases. Accordingly, the weight of the rotor 4 can be reduced, and the cost for the rotor 4 can be reduced.

Furthermore, according to the fourth embodiment, the connection portion 30 engages with the cavity portion 415, and thus the cavity portion 415 can be made to function as a torque transmission portion that transmits torque from the rotor core 410 to the shaft 25.

Except for the above-described features, the fourth embodiment is the same as any one of the first to third embodiments.

### (Air Conditioner)

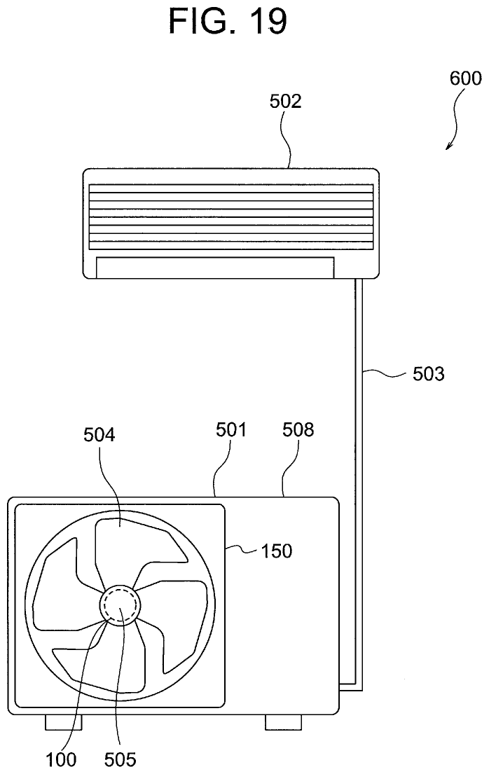

Next, a description will be given of an air conditioner 600 employing the motor 100 including any one of the rotors 1 to 4 of the above-described first to fourth embodiments. FIG. 19 is a diagram showing the configuration of the air conditioner 600. As shown in FIG. 19, the air conditioner 600 includes an outdoor unit 501, an indoor unit 502, and a refrigerant pipe 503 connecting the outdoor unit 501 and the indoor unit 502. The air conditioner 600 is capable of executing an operation such as a cooling operation in which the indoor unit 502 blows cool air or a heating operation in which the indoor unit 502 blows warm air, for example.

The outdoor unit 501 includes an outdoor blower 150 as a blower, a frame 507 that supports the outdoor blower 150, and a housing 508 that covers the outdoor blower 150 and the frame 507.

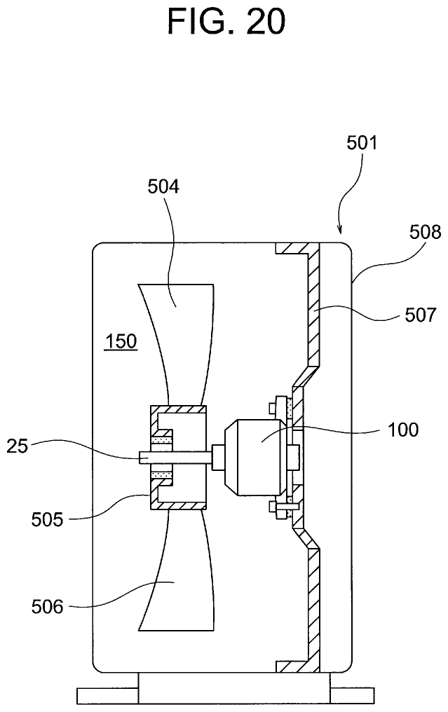

FIG. 20 is a sectional view showing the configuration of the outdoor unit 501 shown in FIG. 19. As shown in FIG. 20, the outdoor blower 150 of the outdoor unit 501 includes the motor 100 attached to the frame 507 and an impeller 504 attached to the shaft 25 of the motor 100. The impeller 504 includes a boss portion 505 fixed to the shaft 25 and blades 506 provided on an outer periphery of the boss portion 505. The impeller 504 is a propeller fan, for example.

When the motor 100 drives the impeller 504, the impeller 504 rotates and an airflow is generated. By this operation, the outdoor blower 150 is capable of blowing air. For example, in the cooling operation of the air conditioner 600, heat emitted when the refrigerant compressed by a compressor (not shown) is condensed in a condenser (not shown) is discharged to the outside of the room by the air blowing operation of the outdoor blower 150.

In the motor 100 including any one of the rotors 1 to 4 in the above described first to fourth embodiments, the vibration and the noise are reduced, and thus quietness of the outdoor blower 150 is improved. Accordingly, quietness of the outdoor unit 501 including the outdoor blower 150 is also improved.

Incidentally, the motor 100 including any one of the rotors 1 to 4 in the above described first to fourth embodiments may be provided also in a blower (for example, indoor blower of the indoor unit 502) other than the outdoor blower 150 of the outdoor unit 501. Further, the motor 100 may be provided also in a household electrical appliance other than an air conditioner.

1. A rotor comprising:
a rotary shaft;
a rotor core supported by the rotary shaft and having a first core part and a second core part arranged to adjoin each other in a circumferential direction; and
a permanent magnet provided in the first core part,
wherein a virtual magnetic pole is formed in the second core part,
wherein the first core part has a cavity portion formed on an inner side in a radial direction of the rotor core relative to the permanent magnet,
wherein the cavity portion has a first portion whose width in the circumferential direction increases toward the rotary shaft, and
wherein a surface defining the cavity portion, being located on an innermost side of the cavity portion in the radial direction and facing outward in the radial direction is located on the inner side in the radial direction relative to an innermost portion of the second core part in the radial direction.

2. The rotor according to claim 1, wherein the cavity portion has a second portion that is connected to the first portion and formed on the inner side in the radial direction relative to the first portion.

3. The rotor according to claim 2, wherein a width of the second portion in the circumferential direction decreases toward an inner side in the radial direction.

4. The rotor according to claim 1, wherein a shape of the cavity portion as viewed in an axial direction of the rotor core is a circular shape.

5. The rotor according to claim 1, wherein the cavity portion has a shape that is symmetrical with respect to a straight line extending in the radial direction through a center of the permanent magnet in the circumferential direction.

6. The rotor according to claim 1, wherein the first core part further has a magnet insertion portion in which the permanent magnet is inserted.

7. The rotor according to claim 6, wherein the rotor core has a plurality of electromagnetic steel sheets which are stacked, and
wherein 0.5≤t₁/t₀≤3 is satisfied where to represents a sheet thickness of one electromagnetic steel sheet in the plurality of electromagnetic steel sheets and t₁ represents a thickness of a portion between the magnet insertion portion and the cavity portion.

8. The rotor according to claim 7, wherein 0.5≤t₁/t₀≤2 is satisfied.

9. The rotor according to claim 6, wherein the cavity portion is connected to the magnet insertion portion.

10. A rotor comprising:
a rotary shaft;
a rotor core supported by the rotary shaft and having a first core part and a second core part arranged to adjoin each other in a circumferential direction;
a permanent magnet provided in the first core part; and
a connection portion that connects the rotary shaft and the rotor core to each other, wherein a virtual magnetic pole is formed in the second core part,
wherein the first core part has a cavity portion formed on an inner side in a radial direction of the rotor core relative to the permanent magnet,
wherein the cavity portion has a first portion whose width in the circumferential direction increases toward the rotary shaft,
wherein the cavity portion is connected to a hollow portion of the rotor core surrounding the rotary shaft, and
wherein the connection portion engages with the cavity portion.

11. The rotor according to claim 1, wherein the second core part has a slit.

12. The rotor according to claim 1, further comprising a connection portion that connects the rotary shaft and the rotor core to each other.

13. The rotor according to claim 12, wherein the first core part further has a projecting portion that projects inward in the radial direction relative to the innermost portion of the second core part in the radial direction, and
wherein the connection portion has a concave portion that engages with the projecting portion.

14. The rotor according to claim 12, wherein the connection portion has an end face portion that covers an end face of the rotor core on at least one side in an axial direction, and
wherein the end face portion has an opening that exposes the cavity portion.

15. The rotor according to claim 12, wherein the connection portion is formed of a resin material having an electrical insulation property.

16. The rotor according to claim 1, further comprising:
a bearing that supports the rotary shaft; and
an insulation member arranged between the rotary shaft and the bearing.

17. The rotor according to claim 16, wherein the insulation member is formed of BMC resin.

18. A motor comprising:
the rotor according to claim 1; and
a stator.

19. A blower comprising:
the motor according to claim 18; and
an impeller that is rotated by the motor.

20. An air conditioner comprising:
an outdoor unit; and
an indoor unit connected to the outdoor unit by a refrigerant pipe,
wherein at least one of the outdoor unit and the indoor unit has the blower according to claim 19.

21. A manufacturing method of a rotor, comprising the steps of:
preparing a rotary shaft;
forming a rotor core that has a first core part having a cavity portion and a second core part in which a virtual magnetic pole is formed, the first core part and the second core part being arranged to adjoin each other in a circumferential direction, the rotor core being supported by the rotary shaft; and
providing the first core part with a permanent magnet,
wherein the virtual magnetic pole is formed in the second core part,
wherein the first core part has the cavity portion formed on an inner side in a radial direction of the rotor core relative to the permanent magnet,
wherein the cavity portion has a first portion whose width in the circumferential direction increases toward the rotary shaft, and
wherein a surface defining the cavity portion, being located on an innermost side of the cavity portion in the radial direction and facing outward in the radial direction is located on an inner side in the radial direction relative to an innermost portion of the second core part in the radial direction.
